(19) United States
(12) Patent Application Publication
(10) Pub. No.: US 2010/0237048 A1
(43) Pub. Date: Sep. 23, 2010

(54) DEVICE TO INJECT A LIQUID FEED TO BE MIXED/CONVERTED INTO A PLASMA PLUME OR GAS FLOW

(75) Inventors: Meryl Brothier, Aix-En-Provence (FR); David Guenadou, Manosque (FR); Patrick Gramondi, Saint Cannat (FR)

Correspondence Address: Nixon Peabody LLP, P.O. Box 60610, Palo Alto, CA, 94306, US

(73) Assignee: COMMISSARIAT A L'ENERGIE ATOMIQUE ET AUX ENERGIES ALTERNATIVES, Paris (FR)

(21) Appl. No.: 12/682,580

(22) PCT Filed: Oct. 9, 2008
(86) PCT No.: PCT/EP2008/063516

§ 371 Date: Apr. 9, 2010

(30) Foreign Application Priority Data
Oct. 12, 2007 (FR) 0758267

(51) Int. Cl. B23K 10/00

(52) U.S. Cl. 219/121.5

(57) ABSTRACT

A device to inject liquid matter into a plasma torch, comprising N(N≧1) groups of injectors arranged on the periphery of a flow region of the plasma, each group comprising at least n (n≧2) injectors which are arranged either side of the plasma flow axis, so as to inject said liquid matter into the plasma in a direction at least partly opposite the direction of plasma flow.

### TECHNICAL AREA AND PRIOR ART

The present invention relates to the area of liquid injection systems into the plume of plasma torches.

Amongst the liquids to be converted inside a torch mention may be made of bio-oils, or sludge from wastewater treatment plants or slurries i.e. particles resulting from powdering a solid, these particles being mixed with a liquid for injection into the plume of a plasma torch.

One of the major problems encountered with methods to gasify liquid feedstock using plasma, particularly with respect to bio-oils, is the best use of the plasma torch to achieve conversion.

Concerning a bio-oil, this is obtained by flash pyrolysis which is a thermochemical process (at a temperature T≈500° C.) in which the biomass is heated rapidly under oxygen non-stoichiometry. Under the effect of heat, the biomass breaks down and leads to the formation of permanent gases, condensable vapours, aerosols and carbon residues. After cooling and condensing the volatile compounds and aerosols, a dark brown liquid is typically obtained: the bio-oil. This is then gasified by injection into a plasma torch.

Pre-treatment of the bio-oil allows the biomass to be injected into the plume of a plasma torch for its gasification. Without this pre-treatment step, the biomass would effectively be heterogeneous and scarcely dispersible (or least without prior, costly crushing) and being solid it would be difficult to inject under pressure. Also in terms of the cost of conveying the biomass to the gasification factories, pre-conversion of flash pyrolysis type may prove to be advantageous.

For proper conversion of liquid, in particular bio-oil, into a syngas using a plasma torch, a good balance is sought between the different parameters influencing the reaction, notably the residence time of the liquid in the plasma plume, the temperature of the plasma plume, the exchange surface between the reactant and the plasma medium and the composition of the medium.

Poor gasification of a bio-oil not only produces poor yield of matter, prohibitive in terms of profitability of the process, but also poor quality syngas i.e. the gas does not have a sufficiently high degree of purity for subsequent use as intermediate in the synthesis of bio-fuel owing to the presence of tars (admissibility threshold close to 0.1 mg/Nm3). The presence of these tars raises numerous problems in the different applications concerned, notably during fuel synthesis using methods of Fischer-Tropsch type in which, under the action of heat and catalyst, soot and a deposit of heavy hydrocarbon compounds are formed. This substantially reduces the lifetime of the catalyst used for Fischer-Tropsch synthesis.

Additionally, the chief characteristics a plasma plume produced by a plasma torch are high temperature (5,000 to 7,000K), high flow rate (800 to 1,200 m·s⁻¹) and high viscosity. With said characteristics the particles which it is attempted to place in the core of the plume have a tendency to rebound on the latter.

There is therefore a real industrial need for a liquid injection device to optimize the dispersion and/or conversion of a liquid in the core of a plasma plume.

The techniques proposed to date to inject a liquid for its dispersion/conversion by a plasma plume can be divided into four main families.

One first family groups together injection methods based on prior atomization of the liquid before its injection into the plasma plume. This type of solution enhances the exchange surface between the reactant and the plasma medium as in patent FR 2 565 992. This method is implemented by means of a device which can be used to place the atomized matter concentrically around the hot gas flow using a vector gas. A rotational movement is imparted to the plasma gas in the plasma generator to obtain turbulence in the atomized matter with concentric flow, the hot gas flow heating the mixture. The fact that it is difficult to impart sufficient speed to atomized liquid is offset by the addition of a vector gas which is given the necessary velocity to enter the plasma plume and by setting up turbulence between the matter to be converted and the hot gas flow. Nonetheless, this method does not allow the plasma plume to be entered at depth and the gasification reaction takes place on the periphery not taking advantage of the high temperatures available deep inside the plasma plume. In addition, the plasma plume is diluted with an additional cold gas, which is penalizing in terms of energy yield bearing in mind that a non-negligible quantity of vector gas is generally required for fine fractionating of a liquid. Also, with a relatively viscous liquid containing fines and likely to coke, the atomization system with use of an injector of relatively small diameter entails a difficulty due to foreseeable clogging of the device.

A second family concerns injection methods based on forcing the mixture. In this case, several configurations can be considered. For example, the plasma can pass through a channel pierced with injection holes compelling the injected liquid to enter into the plasma plume. Various documents mention this technique such as documents FR 1 509 436 or U.S. Pat. No. 5,906,757 for example. In the first cited document, the plasma jet is forced to circulate inside a tube provided with an expanded portion, thereby lowering the pressure of the plasma jet in the expanded portion and hence creating an area of turbulence in the plasma. The liquid is injected in this region and forms a turbulent ring or cylinder around the plasma plume. In the second document, the plasma is caused to circulate in a tube provided with at least one radially arranged injector, which means that the liquid can be injected into the plasma with a tangential component. This type of solution has a favourable effect on residence time since the liquid is injected on the periphery of the plasma plume where the plasma flow rate is not as high (in the order of 100 m/s compared with the rate prevailing at the core of the plume which can exceed 500 m/s.) Nonetheless, this solution generates energy losses due to heat transfer with the channel walls. Additionally, this solution does not force the liquid to enter at depth into the plasma plume, and therefore does not benefit from the temperature effect or from the constituent reactive species of the core of the plasma plume.

A third family groups together injection methods using several plasma torches. One example of embodiment of this method is described in document CA 2 205 578. The principle of this method is to entrap a reactant stream in a confluence of at least two plasma jets, the converging point of the plasma jets lying on the injection axis of the reactant. This type of solution allows liquid to be injected directly deep into the plasma plume. In this case, it is temperature to which preference is given, since advantage is drawn from the high temperatures prevailing at the core of the plasma plume.

This type of solution raises problems of energy losses.

The torch flows are effectively channelled, not leaving any degree of freedom to optimize the injection of the liquid to be converted, as compared with a non-channelled plasma torch configuration.

In addition, the jet is not fractionated and hence heat exchange between the liquid to be converted and the plasma medium is not optimum.

Another problem, the injection at one point does not optimize use of the plume. Use is not made of the entire volume of the plume.

A further problem results from the fact that injection is made at the core of the plume: this gives a short residence time since plasma flow rate at the core is high. Also, due to the use of several plasma torches, any problem or need for maintenance on one of them requires the stoppage of all the torches.

Another problem raised through the use of several torches, is the need to have an electric supply to each torch, which increases energy losses. To offset these heat losses, the number of torches must be increased for a given flow rate, which is not very good from a thermal viewpoint. Finally, the use of several torches can lead to instabilities which are not easily accommodated by a centred injection system.

A last family groups together injection methods using an intermediate part located in the plasma torch. To do so, a device is inserted on the pathway of the gas flow to shape this gas flow, and the fluid matter is conveyed to a nozzle thereby creating a stream of fluid matter whose direction is similar to the direction of flow of the hot gas, as described in patent FR 2 614 751. With this type of device, the fluid is injected directly into the core of the hot gas flow, the particles to be converted thereby being entrapped by the hot gas flow given its high viscosity. This method allows advantage to be drawn from the temperature and residence time in the plasma plume, since it is possible to inject in counter-flow direction to the plasma flow. However the part must be cooled for its mechanical resistance on account of the high temperatures (causing heat losses), this also cooling and perturbing the plasma. Also, risks of clogging may arise during start-up or stoppage phases on account of the temperature at the nozzle.

It can be seen that most liquid injection methods for dispersion/conversion of the liquid at the core of a plasma plume only facilitate one of the parameters from among residence time in the plasma plume, use of the temperature of the plasma plume, the exchange surface between the reactant and the plasma medium, and finally the composition of the medium. The first family is based on the exchange surface between the reactant and the plasma medium, the second on residence time, the third on use of the temperature and the last family gives priority to two parameters—residence time and use of temperature.

Therefore, none of the presented solutions is able simultaneously to meet the following requirements:

optimization of the residence time of the liquid in the plasma plume,

optimal use of the temperature of the plasma plume,

maximized development of the exchange surface between the reactant and the plasma medium,

good use of the composition of the medium for conversion.

The problem is therefore raised of conducting the injection of a liquid for its dispersion/conversion at the core of a plasma plume, to obtain the best balance between residence time of the liquid in the plasma plume, the temperature of the plasma plume, the exchange surface between the reactant and the plasma medium, and the composition of the medium.

### DESCRIPTION OF THE INVENTION

The invention firstly concerns a device to inject liquid matter into a plasma torch, comprising N(N≧1) groups or sections of injectors Gi (i=1, . . . N) arranged on the periphery of a plasma flow region, or away from the flow region of the plasma plume, or outside this flow region, each group or section comprising at least ni (ni≧2) injectors which are arranged for example either side of the axis or plasma flow region or in a plane substantially perpendicular to the plasma flow axis, so that it is possible to inject into the plasma at least part of said liquid matter in a direction at least partly opposite the direction of flow of the plasma.

In most cases, N is ≦15 or 20.

The ni injectors of one same group of injectors Gi can be arranged on the periphery of the plasma flow region, with an angle difference of 360°/(ni) relative to each other. They are preferably arranged to achieve converging of the liquid streams they inject into the plasma. They are not in direct contact with the plume or with a plasma flow region.

At least one injector may comprise a helical inner profile, so as to impart movement with a rotational component which can promote dispersion of the liquid on impact at the core of the plasma plume.

At least one injector may comprise piezoelectric means to fractionate the injected liquid.

A device according to the invention may comprise N groups of injectors (N>1) arranged along the plasma flow axis, injectors of different groups of injectors comprising different angles of incidence relative to the plasma flow axis. This arrangement notably allows better distribution, in the plasma, of the liquid feed to be treated. Preferably, the further distant a group of injectors lies away from the base of the plasma plume, the smaller its angle of incidence with the plasma flow axis.

A device according to the invention may further comprise means to inject, in at least part of the injectors, pulsed trains of liquid streams for example or liquid streams under oscillating pressure (time variable).

Advantageously, one or more injectors also each comprise a vapour injection nozzle to inject a stream of vapour simultaneously with the stream of liquid.

A device according to the invention may further comprise means to pressurize the liquid feed to be converted. The pressure of some streams can be modified, notably in some stream configurations, so as to allow adjustment of the stream injection angle whose precision is modified.

Advantageously, means can be provided to separate on the one hand the heavy organic compounds in the liquid to be converted, and on the other hand the light phase of this same liquid.

Means to prepare a liquid to be injected may also comprise means to vaporize the aqueous phase before it is injected.

A device according to the invention may further comprise optical means to control the quality of injection, and optionally to adapt the injection parameters of the liquid to be converted to modifications of the plasma plume.

More generally, means can be provided so that injection of the liquid feed to be converted can be adapted to changes in the plasma plume.

The invention also concerns a method to inject liquid matter into the plume of plasma torch, in which the liquid is injected via N(N≧1) groups of injectors Gi (i=1, . . . N) arranged on the periphery of a plasma flow region, or away from the flow region of the plasma plume, each group comprising at least ni (ni≧2) injectors arranged for example either side of the plasma axis or flow region or outside this region and/or in a plane substantially perpendicular to the plasma flow axis, at least part of said liquid matter being injected in the plasma in a direction at least partly opposite the direction of flow of the plasma.

Here again, the n injectors of one same group of injectors can be arranged on the periphery of the plasma flow region, with an angle difference of 360°/n relative to each other. They are preferably arranged so as to achieve converging of the streams of liquid they inject into the plasma.

A device and a method according to the invention, apply particularly well to a liquid of bio-oil type, or to the sludge of a wastewater treatment plant, or to slurry.

Part of the heat emanated by the plasma can be recovered by the part supporting the injectors and then transferred, by conduction, to the liquid passing through the injectors.

It is advantageously possible, to inject, in at least part of the injectors, pulsed trains of liquid streams for example or liquid streams whose injection pressure varies periodically (oscillation).

According to another advantageous embodiment, in at least part of the liquid streams, it is possible to inject a stream of vapour simultaneously with the stream of liquid. The liquid can be previously separated between a first part, vaporizable at relatively low temperature (in the order of around 80 to 150° C.) and a second heavier part to be injected in the plasma in liquid form.

Addition of water to the liquid to be injected can also be made to optimize the conversion reaction of the liquid to be treated.

According to another particularly advantageous embodiment a layer of vapour is formed outside the plasma plume.

The liquid streams of the n injectors of one same group of injectors are preferably confluent in the plasma, the region of confluence of the streams advantageously being located substantially on the plasma flow axis.

The angle of injection of at least one stream in the plasma can be modified, for example by varying the pressure of the fluid in this stream.

Controls of various parameters can be carried out, for example:

the quality of injection of the liquid streams, using means of optical type for example;

and/or the quality of the plasma leaving the torch;

and/or the pulsing of the plasma plume, optionally with respect to the pulsing of the liquid injected into the plasma plume.

To allow adjustment of the parameters of the system using data corresponding to one or more measurements made, it may be desirable to be able to adjust the composition of the feed and/or the operating conditions of the plasma if the need arises. For example, it may be desired to adjust phase shifting between a pulse period of the plasma plume and a pulse period of injection.

### BRIEF DESCRIPTION OF THE DRAWINGS

FIG. 1A shows details of an example of embodiment of a device according to the invention.

FIG. 1B shows details of an example of embodiment of a system according to the invention.

FIGS. 2A to 4 show examples of injector profiles used in a device according to the invention.

FIGS. 5 and 6 illustrate problems encountered when a liquid stream passes through the plasma plume (in the event of excess quantity of movement of the liquid stream) and the case in which the quantity of movement of the liquid stream is insufficient not permitting entry into the plasma cone.

FIG. 7 illustrates an impact with maximum fractionating of streams which converge at almost 90° just before impact.

FIGS. 8A and 8B illustrate the impacting of streams with non-orthogonal confluence inducing the formation of a sheet of liquid.

FIG. 9 shows a configuration comprising several sections of injectors along the axis of the plasma torch.

FIGS. 10A to 10C show the pulsed injection of trains of liquid streams to minimize the risk of saturating the plasma plume.

FIG. 11 illustrates possible positioning of an assembly of 3 pairs of injectors along the axis of the plasma torch and along two axes perpendicular to each other.

FIG. 12 shows a profile of the heat exchange coefficient at the wall in relation to the flow axis xx′ of the plasma plume, and the plasma plume and portions of the wall.

FIG. 13 schematically illustrates the positioning of an injector and vapour injection nozzle.

FIG. 14 illustrates the forming of a boundary layer of vapour high in water at the limit of the plasma plume to avoid the formation of soot.

FIG. 15 is a standard illustration of a phase diagram for a system of water/bio-oil type.

FIG. 16 shows one of the optical interfaces of the reactor, allowing diagnosis of the injection by optical measurement.

FIG. 17 is a detailed illustration of the distribution of an assembly of three pairs of injectors, in one same plane along a plasma flow axis.

FIG. 18 is a schematic illustration of elementary volumes of the plasma plume, to estimate the occupancy rates of the plume by the liquid feed to be converted.

FIG. 19 shows the formation of a sheet of liquid by the converging of two liquid streams.

FIG. 20 shows the changes in the radius (r) of the sheet of liquid in relation to angle β and the angle of incidence of the streams (θ).

FIG. 21 shows an example of electric arc fluctuation inside the plasma torch, by time monitoring of the voltage at the torch electrodes.

FIG. 22 schematically illustrates the distribution, on the circular section around a plasma plume, of three liquid injectors.

### DETAILED DESCRIPTION OF PARTICULAR EMBODIMENTS

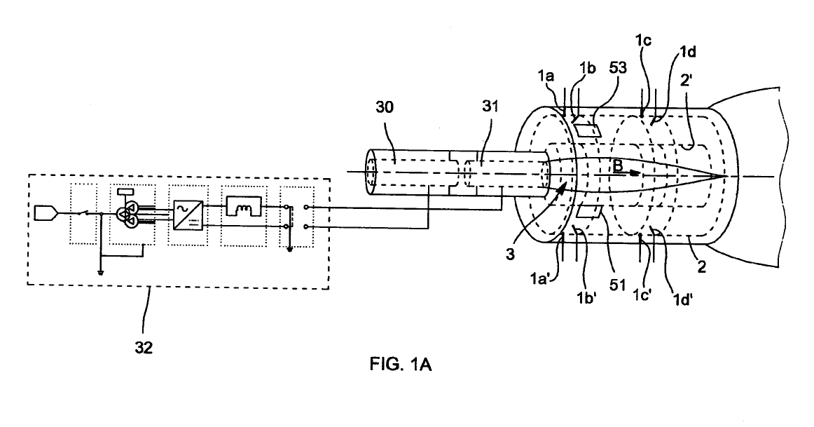

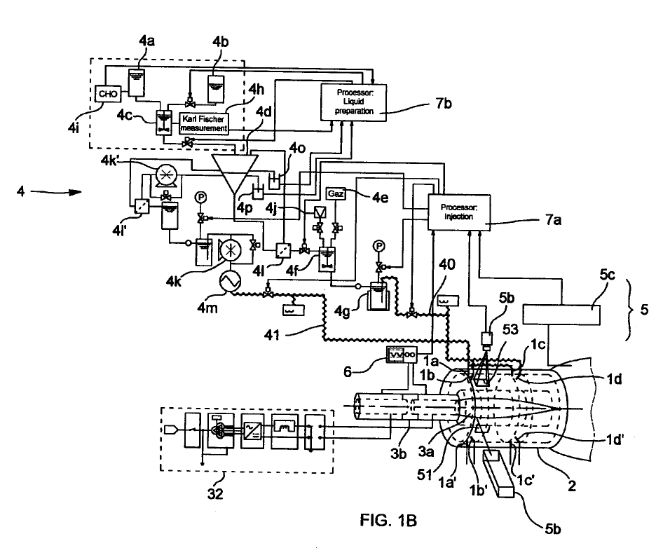

One embodiment of the invention will be explained in connection with the schematic shown in FIG. 1A.

FIG. 1B includes said device with additional peripheral means described further on.

In FIG. 1A, references 30, 31 designate electrodes between which an electric discharge is produced. Simultaneously, the passing of a plasmagenic gas between these electrodes leads to the formation of a plasma plume 3.

Electric supply means for the electrodes are designated as reference 32.

At the output of the electrodes, a system is arranged which forms a support 2 for the positioning and holding in place of the injectors injecting the liquid to be treated. In a cavity 2′ arranged in this support, the plasma plume flows substantially along an axis B designated hereinafter as the plasma flow axis. In one example the cavity 2′ is of substantially cylindrical shape and axis B is an axis having cylindrical symmetry with this cavity. However other shapes can be chosen for this cavity.

In this support 2 at least two injectors are arranged, forming a group of two injectors.

More generally, it is N groups Gi of injectors (N≧1, but generally N≦15 or ≦20) that are arranged in this support, each group Gi comprising at least two injectors and, more generally ni (ni≧2) injectors. The N groups of injectors are arranged along the plasma flow axis. The arrangement of these injectors is described in more detail below.

FIG. 1A schematically illustrates 4 liquid injectors designated under references 1b, 1d, 1b′, 1d′. These have been divided into two groups G1 and G2 each having two liquid injectors. A distinction is also made in this same figure between 4 other injectors or nozzles 1a, 1c, 1a′, 1c′ which, as explained below, are used for the separate injection of vapour, each thereof cooperating with one of injectors 1b, 1d, 1b′, 1d′.

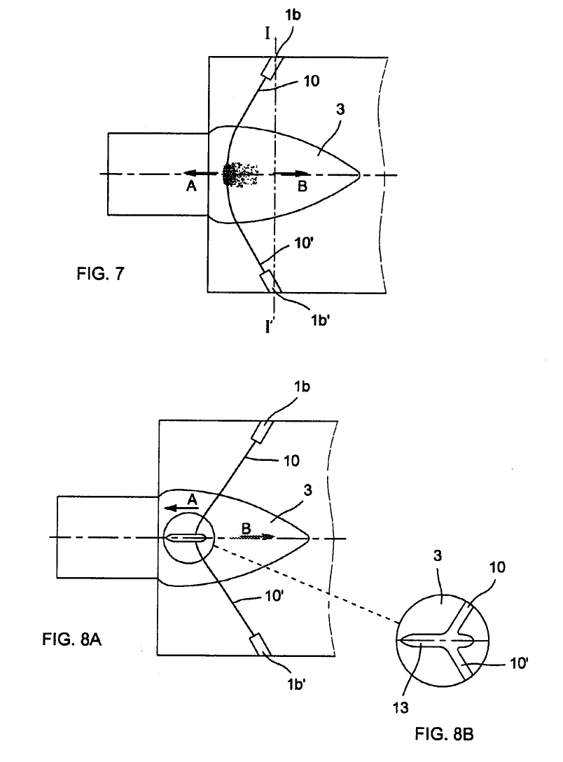

The liquid injectors 1b, 1d, 1b′, 1d′ are directed towards the region in which the plasma plume 3 is to be formed, so as to inject the liquid with a movement containing a component along direction A (see arrow A in FIGS. 7, 8, 9, 10A-C, 14, 17) opposite the direction of flow B of the plasma (see also arrow B in the same figures). The injectors here are arranged in groups of two or pairs, each pair, or outlet orifices of these injectors (orifices through which the matter to be treated is expelled towards the plasma), forming an axis I-I′ (see FIG. 7) substantially perpendicular to the axis or direction of flow B of the plasma, the two injectors of each pair being arranged substantially diametrically opposite on the periphery of the support 2 and being directed towards the region in which the plasma 3 is formed.

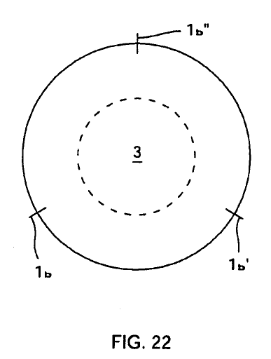

If a group Gi of injectors comprises 3 injectors—and more generally ni injectors—these, or their orifices, are arranged substantially in one same plane perpendicular to the plasma flow axis (in FIG. 7 the trace of this plane would be I-I′, perpendicular to the plane of the figure and to axis B). They are then preferably arranged substantially at 120°—and more generally at 360°/n—relative to each other (see for example FIG. 22 which gives a schematic cross-sectional view of an injection support 2, perpendicular to the plasma flow axis B, with a group of 3 injectors 1b, 1b′, 1b″ in one same plane substantially at 120° to each other).

In relation to the plasma flow axis B, the angles of the projection axes of the liquid at the injector outputs of one same group of injectors, or the output axes of the injectors of this group (these injectors being arranged substantially diametrically opposite relative to the plasma flow axis if ni=2), on the periphery of the support 2 (see injectors 1b and 1b′ in FIGS. 1A, 1B, 7, 8, 10A-10C), are substantially equal to one another (in absolute value).

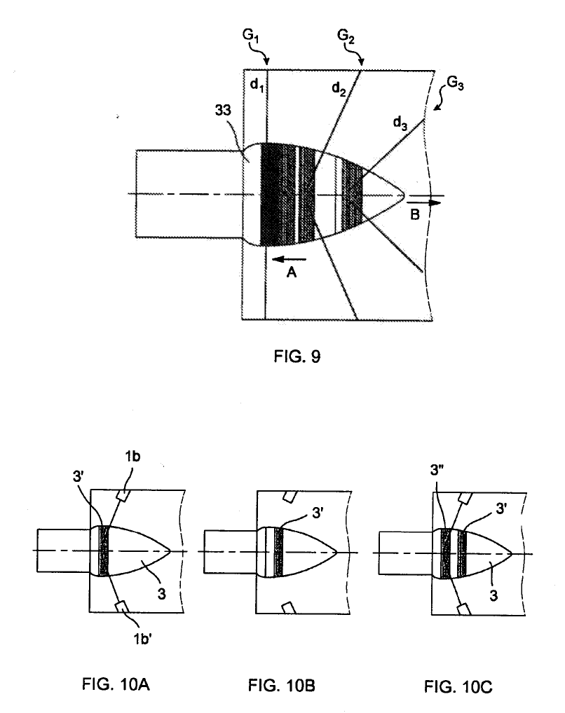

A more complex structure is illustrated in FIGS. 9, 11, 17, 18, in which the device comprises 3 pairs or groups G1, G2, G3 of injectors, 1b, 1b′, 1d, 1d′, 1f, 1f′ arranged along axis B, on 3 different axes but perpendicular to axis B. Here again, the angles relative to the plasma flow axis B formed by the projection or output axes of the injectors of one same group (these injectors lying on the periphery of the plasma flow region but at one same position along the flow axis of this plasma i.e. substantially on one same axis perpendicular to this flow axis) are substantially equal in absolute value. Therefore in FIG. 17, the angle of the axis of each of the injectors 1b, 1b' (group G1) with axis B is n/2, the angle of the axis of each of injectors 1d, 1d′ (group G2) with axis B is n/4, and the angle of the axis of each of injectors 1f, 1f(group G3) with axis B is π/6.

More generally, irrespective of the number ni of injectors in one same group Gi (these injectors are therefore arranged in one same plane perpendicular to the direction B of plasma flow):

the angles formed by the projection or output axes of these injectors, lying in this same plane, with the plasma propagation axis, are equal or substantially equal to each other.

or the angles formed by the directions of incidence of the streams of the injectors in this group entering into the plasma, with the plasma propagation axis, are equal or substantially equal to each other.

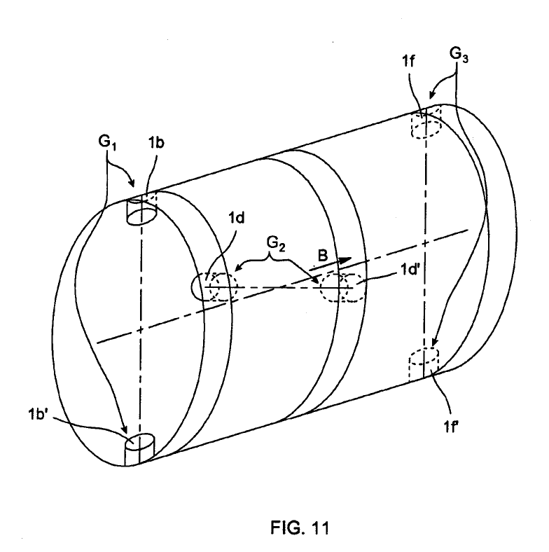

For practical reasons the injectors in FIG. 17 are shown in one same plane (the plane of the figure) but they are preferably arranged as shown in FIG. 11, i.e. along axes that are alternately orthogonal to each other and to the direction of the plasma flow. In FIG. 11 therefore, 3 groups of injectors can be seen G1, G2, G3 and all the angles between the projection axes and the plasma flow axis are substantially equal to 90°; the angle at the tip of the cone formed by the injectors and the point of convergence on the plasma flow axis is then substantially 180°.

It can be seen in the embodiments shown in FIGS. 9, 17, 18 that the further the injectors of a group of injectors lie distant from the base 33 of the plasma plume 3, the smaller the angle of incidence formed by the injectors of this group with this axis (in FIG. 17, the angle π/2 for injectors 1b, 1b′ changes to angle n/4 for injectors 1d, 1d′, then to angle π/6 for injectors 1f, 1f′ which lie the furthest away from the base of the plasma). As explained further on, this arrangement allows an optimized occupancy rate in the plasma whilst reducing risks of plasma saturation.

Therefore, irrespective of their number, the injectors of one same group, through their positioning in the support 2 and their orientation, can compel converging of the streams (continuous or discontinuous), enabling each stream to lean on the other(s) to fractionate at the propagation axis of the plasma plume.

Through this orientation of the injectors, the quantity of movement resulting from the converging streams largely occurs in direction A opposite the flow B of the plasma plume. This ensures an increased residence time of the matter to be converted in the plume, and optimal secondary fractionating by the plasma plume. Since the matter is injected with a quantity of movement driving it in the direction opposite the direction of plasma propagation, an additional time period is necessary for it to be driven by the latter, compared with injection in the same direction as the plasma. In addition, the secondary fractionating induced by the plasma plume is a function of the relative velocity between the plume and the fluid to be converted: the opposite directions firstly of the liquid and secondly of the plasma flow, ensure optimization of this relative velocity.

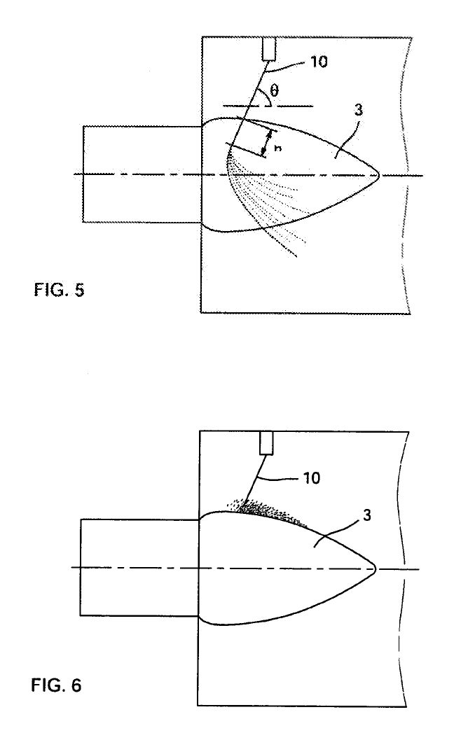

As can be ascertained in FIGS. 5-10C, 13, 14, 17, 18, the injectors are not in contact (nor in the immediate vicinity of) the plume. The risks of coking are therefore minimized (phenomenon due to the temperature at the injectors) and hence also the risks of injector clogging. Also, the need to cool the injectors is lower, which enhances thermal yield, the flowing of liquid at relatively high velocity for a liquid (cf. the example of embodiment given below) ensuring temperature limitation which in some cases can allow the circumventing of specific cooling. This cooling can be ensured by the feed to be converted and, advantageously, by the non-cokable part derived from upstream of the line 41 (FIG. 1B). This beneficial effect on heat transfer is reinforced by the fact that, in the present invention, the plasma plume 3 is no longer channelled by walls which closely follow its contour. Since the walls of the cavity 2′ and the support for the injectors 2 lie relatively distant from the plasma plume, or do not have a plume confining role, heat losses can be limited, which leads to an increase in energy yield.

In general, the injector-input distance into the plasma plume (which by way of indication can be in the order of 10 times (even more) the diameter of the plume) ensures a stream time-of-flight before its entry into the plume which completes heating of the stream, and can optionally volatize a fraction of the light species (which may have remained in the injected liquid stream) which do not necessarily require the high temperatures prevailing at the core of the plasma plume to be converted. This optimizes the residence time of the stream in the plume, and allows the plasma plume to be used specifically for species particularly refractory to conversion.

The injectors arranged in the above-described manner, in relation to the quantity of movement available for each stream, allow the liquid feed to be injected into the plasma plume 3 (or into the dense hot flow) so that it passes entirely through the latter as far as the plasma flow axis, and so that the streams converge substantially on this axis and lean on each other at the time they meet, which increases their fractionating. This avoids the situation illustrated in FIG. 5, in which the stream only partly crosses through the plasma plume, and can only reach the axis with significant spraying, or even a situation of its non-entry into the plasma (FIG. 6). In the case shown in FIG. 6, the stream of liquid 10 breaks up on mere contact with the edges of the plasma 3. FIG. 17 illustrates the three points A1, A2, A3 (all three lying on the plasma flow axis B) where the streams from the different groups of injectors converge.

This fractionating, after converging of the streams substantially on the plasma flow axis, allows optimized dispersion as soon as impact is made by the streams (case with maximum fractionating, and with an impact having practically perpendicular confluence just before converging as illustrated in FIG. 7) or with rather more reduced, non-orthogonal confluence (case with a flow such as illustrated in FIGS. 8A, 8B, in which the streams 10, 10′ arrive at a smaller angle to the plasma flow axis, and the injectors are located further downstream on this axis compared with the configuration shown in FIG. 7). In the first case (FIG. 7) primary fractionating is facilitated, whilst in the second case there is an increased residence time of the matter in the plasma plume 3 and an increase in the exchange surface (the liquid passes from one cylindrical section 10, 10′ to a sheet 13, FIG. 8B) between the liquid to be converted and the plasma plume 3.

Before fractionating, imposed by the shearing forces induced by the flow of plasma 3, it is preferably sought to achieve confluence of the streams 10, 10′ from the injectors of one same group of injectors, or from injectors lying in one same plane, or on one same axis perpendicular to the plasma flow axis. By confluence is meant impacting of the streams 10, 10′ together before they are fractionated; this situation of confluence is illustrated in FIG. 7, FIG. 6 illustrating the problem of non-entry of the stream into the plasma plume. FIGS. 7, 8A and 8B illustrate how to overcome the risk of partial crossing or non-entry of the plasma plume by the liquid stream. FIGS. 8B and 19 give a more detailed view of the formation of a sheet of liquid 13 by the confluence of two streams 10, 10′.

The point or region of confluence, lying on the plasma flow axis, forms the tip of a cone whose generatrixes are formed by an imaginary line connecting the point or region of confluence with the output orifice of each of the injectors whose streams converge at this point or region of confluence, hence each of the injectors of one same group of injectors. The semi-angle at the tip of the cone is equal to the angle formed between the direction of injection of each liquid injector and the plasma flow, or to the angle formed by the direction of the incident stream at the point of confluence and the plasma flow axis.

Therefore, in FIG. 17 the group of injectors 1d, 1d', together with the point of confluence A2 of the streams of these two injectors, forms a cone whose tip is precisely point A2. Each of the straight lines Δ2, Δ′2 which connects this point with the outlet orifice of one of these two injectors forms a generatrix of the corresponding cone.

Similarly, in this same FIG. 17, the group of injectors 1f, 1f together with point of confluence Δ3 of the streams from these two injectors, forms a cone whose tip is point Δ3. Each of the straight lines Δ3, Δ′3, connecting this point A3 with the outlet orifice of one of these two injectors, forms a generatrix of the corresponding cone.

The confluence of at least two streams, and the optional formation of a sheet of liquid, allows optimization of the exchange surface and of the residence time in the plasma plume.

The converging streams are therefore atomized directly in the plasma, benefiting from the impacting between the streams, from the shearing effect caused by the plasma flow and from the highest temperature (the temperature at the core of the plasma) and from reactive species.

The confluence of the streams allows a problem to be overcome, namely the optimization of the quantity of movement allowing the liquid to be inserted into the core of the plasma plume. It is effectively only necessary to impart a sufficient quantity of movement to the stream so that it is able to enter into the plume, but without the risk of the stream passing through the plume in the event of, even limited, exceeding of the maximum quantity of movement (which, at least in order of magnitude, is practically equal to that of the plume). This gives an additional degree of freedom and double fractionating (namely fractionating by the plasma [difference in velocity between the liquid and the plume] and fractionating due to impact) whilst allowing a compromise to be achieved between the reaching of high temperatures by the plasma and the residence time of the liquid inside the plume.

The length h (FIG. 5) of the continuous stream 10 entering into the plasma plume and not subject to fractionating is:

firstly (in order of magnitude) a function of the square root of the ratio (denoted q) between the quantity of movement of the liquid stream 10 and that of the plasma plume 3; preferably q is greater than 1, further preferably greater than 2,

secondly, a function of the angle of injection (denoted θ, this is the angle between the plasma flow axis and the directions of the streams),

but also a function of the reduced distance (ratio between the length x of the stream before it enters the plume and the diameter (d) of the injector of the injected stream).

It is possible, depending on flow characteristics, to find an optimal angle (θ*) making it possible to maximize the length of the stream (hmax) before fractionating. In flow schedules in which hydrodynamics have priority over thermal effect (hypothesis in which a stream is maintained in the liquid state before being fractionated in the plume) the length of the stream without fractionating can be approached using an expression of the type:

h=f(θ,x/d)\sqrt{q}; where hmax=f(θ*,x/d). \sqrt{q}

In this expression, x and d are fixed for a given configuration.

Therefore (in the case in which the angle of injection is not dependent upon quantity of movement, as is the case for an injector outlet with no profile), there are no more than two degrees of freedom (θ and q) to optimize injection. The range of variation of parameter θ is smaller than for parameter q.

The multiplicity of injectors (two per section or group of injectors in FIGS. 1A and 1B, three in FIG. 22, but provision may be made for more in one or more groups of injectors) makes it possible to increase the exchange surface and to make better use of the volume of the plasma plume, by avoiding saturation thereof with the feed to be treated. For this purpose, it is sought to guarantee a maximum plume occupancy rate or saturation rate to avoid its congestion without too great a reduction, however, of percentage feed in the plasma plume (otherwise the treatment of one kilogram of liquid feedstock to be converted would be too costly). In general, it is sought:

to inject the maximum allowable quantity of feed, having regard to the power supplied by the plasma plume 3 and to the transformation enthalpy of the feedstock,

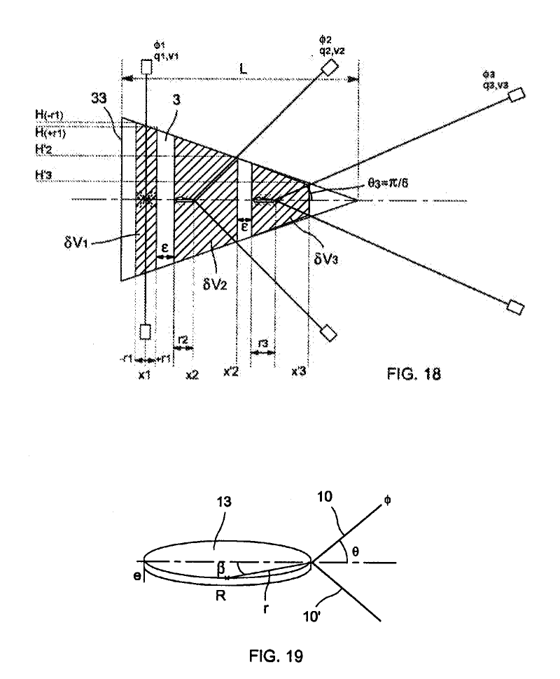

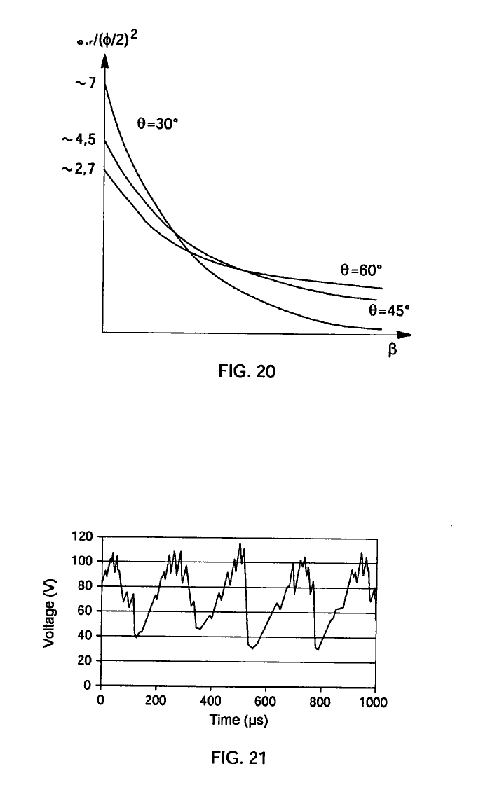

to minimize risks of local saturation of the plume with liquid feed, and hence to seek to guarantee good distribution of the liquid feed within the plume (cf. FIG. 9 in which the grey shades give an indication of the liquid feed content in the volume of the plume); therefore, at the convergence of the streams, the feed content is high (especially at the first confluence the closest to the base 33 of the plasma, see FIGS. 17 and 18 and the example of embodiment given below) and tends to decrease due to the greater or lesser extent of conversion just upstream of a new injection). The quality of distribution cannot be pre-assumed to be optimal, but it can nonetheless be a priori approached (see in this respect the example of embodiment given below) and adjusted a posteriori by controlling the quality of injection using suitable diagnosis, for example using means 5 and 6 in FIG. 1.

The saturation rate may vary in relation to the type of plume and the physicochemical properties of the feedstock to be treated (volatility, surface tension, . . . ). As an indication, a local feed content of less than 1% (volume of liquid over elementary volume of the plume section encompassing this volume of liquid (cf. δVi defined in the example of embodiment) can protect against the risk of saturating the plume (bearing in mind also that there is a factor of at least 1,000 between the volume occupied by a liquid and the volume occupied by its vapour if the liquid is vaporized).

To minimize risks of plasma congestion, it is therefore possible to apply the following configurations:

groups of injectors distributed as per different longitudinal points of the plasma plume (see the structures in FIGS. 9, 10A-C, 17, 18) and/or with different axes of incidence or angles of injection (see the same figures in which all the groups of injectors have different angles of injection from one group to another),

and/or injection of trains of liquid streams in pulses, potentially phase shifted between sections or groups of injectors (for pulsed injection) to distribute the feed content of the plasma (or hot gas flow enabling conversion). This situation is illustrated in FIGS. 10A-10C, in which only 2 injectors 1b, 1b′ are shown, first with each emitting one stream of matter; this matter 3′ will initially be localized in a front region (FIG. 10A) of the plasma 3, then driven in the direction of plasma flow whereas the injectors no longer emit any matter (FIG. 10B); when the injectors each emit a new stream of matter 3″, this is first located in a region upstream of the plasma (FIG. 10C), upstream of the region in which the matter 3′ now lies injected by the first stream. The time separating the end of a liquid injection pulse and the start of the following pulse is preferably at least the displacement time of the elementary volume of plasma; in other words, it is sought to inject into the plasma a volume of liquid which permits sufficient renewal of the injection region into the plasma, to allow a new injection pulse.

This notably allows alternating injections between different sections of injectors, the flow rate of the gas flow generally being very high (the case with a plasma plume).

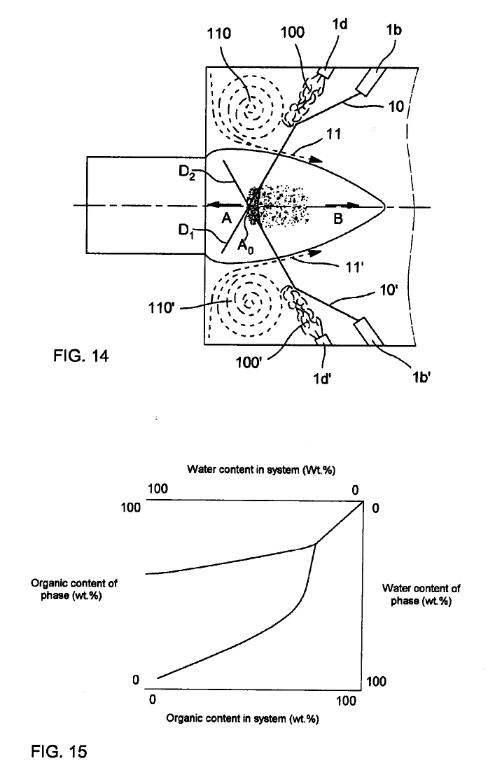

According to another embodiment, which can be combined with the preceding embodiments, means can be provided to inject a vapour, as illustrated in FIGS. 1A, 13 and 14 in which vapour injectors or nozzles 1d, 1d′ are arranged each to inject a stream of vapour 100, 100′ in a direction forming an angle γ with the direction of injection 10, 10′ of the liquid feed injectors 1b, 1b′. This injection of vapour provides an additional degree of freedom for the resulting angle of injection between the liquid stream and the plasma plume. As can effectively be seen in FIGS. 13 and 14, the vapour 100, 100′ diverts the initial pathway of the of the liquid to a greater or lesser extent, in relation to the ratio between the quantity of movement of the vapour stream and that of the stream of liquid feed to be converted. In this case, the point or region of confluence A0 lying on the plasma flow axis B forms the tip of a cone whose generatrixes are formed by the directions D1 and D2 of the streams incident to this point of confluence.

The injected gas may advantageously be the easily volatilizable part (at a temperature of between around 80 and 150° C. for example) of the liquid to be converted (i.e. the part which a priori does not necessarily need to be injected into the plasma to be vaporized or converted). This fraction, by nature (since consisting of light elements) is less subject to the phenomenon of coking. To inject this volatilizable part in the form of vapour, it is possible to conduct prior de-mixing, to separate the organic part of the liquid to be converted which is scarcely volatilizable and rather refractory to conversion and therefore requiring plasma treatment, from the vaporizable aqueous part generally easier to convert. Means to carry out said de-mixing are described further on with the feedstock preparation means.

The quantity of this vaporizable aqueous part may optionally also be adjusted through the injection of additional water to guarantee complete gasification of the bio-oil in the event of oxygen and hydrogen deficiency, notably due to a specific composition of the bio-oil.

By way of indication, a bio-oil with a mean empirical formula of type (CH_{1,9}O_{0,7}), requires an equivalent quantity of water of 0.3 mole per mole of bio-oil, in order to be fully gasified as per the formula:

CH_{1,9}O_{0,7}+0,3H₂O→1,25H₂+CO (reaction 1).

In this reaction, an insufficient amount of water would nevertheless lead to a reaction, but a reaction lacking equilibrium which will lead to the formation of soot.

A fractionated injection (injection of the volatilizable part in vapour form and of the non-vaporized part in liquid form into the plasma), as explained above, not only allows adjustment of the quantity of water but also reservation of the occupancy of the core of the plasma region for the feedstock that is most difficult to convert, for complete destructuring of this feed and its least possible diluting with other compounds not necessarily requiring very high temperatures for conversion. In other words, only matter which must be converted in the plasma is injected into the plasma, the part that is vaporisable outside the plasma advantageously being used otherwise.

Also, in addition to the effect of changing the angle of injection of the liquid stream and of adjusting the stoichiometric composition, the injection of vapour optionally allows prior heating of the liquid feedstock before it enters the plasma. It also permits minimization of the presence of soot (solid phase derived from poor gasification of the liquid feedstock) output from the plume 3. Since water vapour effectively does not have sufficient quantity of movement relative to movement of the plasma plume 3 in order to enter the latter, it is re-circulated as illustrated in FIG. 14, its driving movement being induced by the plasma plume 3, thereby forming a layer of vapour 11, 11′ with high water content on the boundary of the plasma plume. References 110, 110′ designate a cloud of circulating vapour accumulated either side of the plasma subsequent to the injection of vapour, which will form the layers 11, 11′. Soot forms very rapidly (speed of formation under one thousandth of a second) involving phenomena of growth and clustering; it is therefore of interest to shield the plasma plume with these regions 11, 11′ high in water vapour to limit this formation of soot that is relatively refractory to gasification once it has reached a penalizing size (possibly exceeding one micron) in terms of gasification.

To minimize the formation of soot, it is also possible to act on the composition of the plasmagenic gas directed into the torch. The composition of the plasmagenic gas can be controlled at the injection point into the plasma-forming electrodes (FIG. 1A).

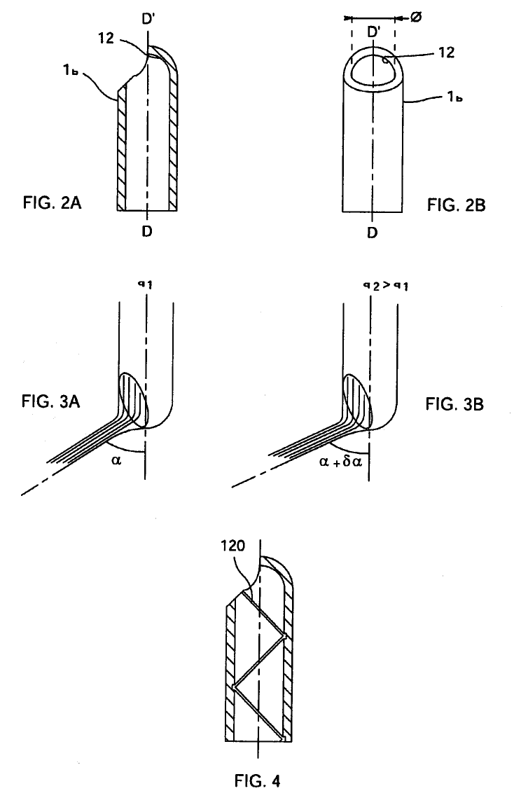

The liquid injectors 1b, 1b′, 1d, 1d′ may for example have profiled outlets whose orifice 12 of maximum diameter or size Φ, not only avoids undue clogging due to the presence of fines in the liquid to be injected, but also guarantees satisfactory distribution of flow in the plasma plume at their end points. Said injector is schematically illustrated in FIGS. 2A and 2B, by way of illustration, in a front and cross-sectional view. The orifice 12 is not symmetrical with a direction defined by the axis of extension DD′ of the injector. This orifice directs or diverts the liquid towards one of the sides of the axis DD′.

These profiled parts, depending on imposed fluid pressure upstream of the outlets, optionally permit a variable angle of injection α+δα to be imposed within a limited range δα, the limit being imposed by the profiled part and by the flow as illustrated in FIGS. 3A and 3B: in these figures, a first pressure corresponding to a first quantity of movement q1, allows an angle of injection to be obtained that is equal to a (FIG. 3A), whilst a second pressure corresponding to a second quantity of movement q2>q1 allows an angle of injection to be obtained equal to α+δα (FIG. 3B). With this profiled part, it is therefore possible to adjust the angles of injection of the liquid to be converted, merely using pressure, without having recourse to mobile parts which are difficult to implement in a method with major temperature and sealing constraints.

The inner wall of these outlets may also have a helical thread 120, as illustrated in FIG. 4, making it possible to pulse a quantity of rotational movement to the fluid, the consequence of which is to allow increased fractionating of the liquid inside the plasma plume 3. With this option, it is possible to inject continuous or discontinuous streams.

According to another example, the injectors, which then can be of the type described above, or even straight outlets, can be equipped with piezoelectric elements to vibrate the injector and fractionate the liquid. With this option, it is possible to inject trains of discontinuous streams. More generally, fractionating can be facilitated by having recourse to suitable phasing between pulsing of the plasma plume due to movements of the electric arc within the plasma torch, and pressure pulsing of the liquid stream to be converted.

Means to pressurize the feedstock to be converted, identified in FIG. 1 under references 4g, 4g′, can ensure the rate of injection and hence the quantity of movement of the liquid to be injected. These means, described further on, can allow adjustment of the pressure and can be driven by means 7a for example (FIG. 1B) of microprocessor type.

In general, in addition to occupancy rate and stream length before fractionating, the following elements can notably be taken into consideration to optimize injection:

the travel time of the stream before it converges with another stream (this time is broken down into the time-of-flight before entry into the plume and the travel time inside the plume). This time optionally allows the temperature of the liquid to be raised and thereby its fractionating to be increased at the time of stream impacting, through the induced decrease in viscosity,

the fragmentation time of the stream into droplets,

the time to reach equilibrium with the flow velocity of the plasma plume, for a droplet derived from fractionation after stream impacting (a droplet in equilibrium undergoing practically no further fractionation by shearing);

droplet evaporation time (at least for the volatilizable part),

the residence time of the liquid in the plasma plume (without counting the time-of-flight before impact).

Following Table I gives the orders of magnitude of each of these times, bearing in mind that they do not all correspond to phenomena whose contributions may be equivalent with respect to feedstock conversion. Chemical conversion times are unknown in a plasma medium, therefore no value is given.

The present invention enables optimized injection of the liquid feedstock so that physical phenomena (in particular fractionation and evaporation) are optimized.

TABLE I

| | Time-of-flight in | | | | |
|---|---|---|---|---|---|
| | plume before | | Time to | Characteristic time | Residence |
| Characteristic | stream | Fragmentation | hydrodynamic | for droplet | time (after |
| times | intersection | time | equilibrium | evaporation | impact) |
| Order of | ~10⁻² s | <10⁻³ s | <10⁻¹ s | ≦10⁻³ s | ~10⁻³ s |
| magnitude | | | | | |

The most important parameters for conversion of the liquid feedstock are fragmentation time, the characteristic time for droplet evaporation and residence time (after impact).

The time for droplet equilibrium is relatively long compared with the other phenomena, but it is not necessary to seek this equilibrium at any price (placing in hydrodynamic equilibrium in fact only translates the fact that all the shearing potential of the plume has been used, the relative plasma/liquid velocity being zero as soon as this equilibrium is reached).

The time-of-flight inside the plume before impact is not negligible compared with the residence time after impact.

This analysis indicates that it is preferable to proceed with fragmenting the liquid as far upstream as possible of the plasma flow (without saturating the plume) and as much as possible along the longitudinal axis of symmetry (axis B) of the plasma flow, this approach maximizing the residence time of fine droplets inside the plasma plume.

The means or device which forms a support 2 for the injectors, contributes towards their proper positioning and holding in place. These means are joined to the torch.

The support for the injectors may comprise means to receive N(N≧1) group(s) Gi (I=1, . . . N), each comprising ni injectors (ni≧2) positioned as explained above. Two different groups of injectors Gi and Gj (i≠j) may comprise a different number of injectors ni and nj to each other. Since the injector support surrounds the plasma plume, it is ring shaped and can be divided into sections (2a, 2b, 2c) to obtain a degree of freedom with respect to the angles between the different planes of injection (one group of two injectors forms one plane (plane of injection) with the point of convergence of the two streams derived from these injectors) as can be seen for the case illustrated in FIG. 11 in which these planes are alternately perpendicular to each other. Each group of injectors in FIG. 11 comprises two injectors. These two injectors also define an axis, perpendicular to the plasma flow axis B, but also a plane with the point of convergence.

To enable the injectors to operate under optimized conditions, regarding temperature and angle of injection in particular, the support allows maintaining of the temperature of the liquid to be injected, notably to control its viscosity and to complete preheating which may have taken place upstream during an optional feedstock preparation step, as explained below. Since the liquid, before injection is hence brought to a temperature close to the conversion temperature, the residence time in the core of the plasma plume is optimized since it is not or only little used to heat the liquid but rather more to convert the liquid rapidly after its fragmentation.

The material of the support and/or of the injector can be of any refractory type whilst allowing sufficient heat transfer to allow transfer of heat able to ensure pre-heating of the liquid to be injected, without inducing surface temperatures which are too high for the injector support or coking risks of the feed to be injected.

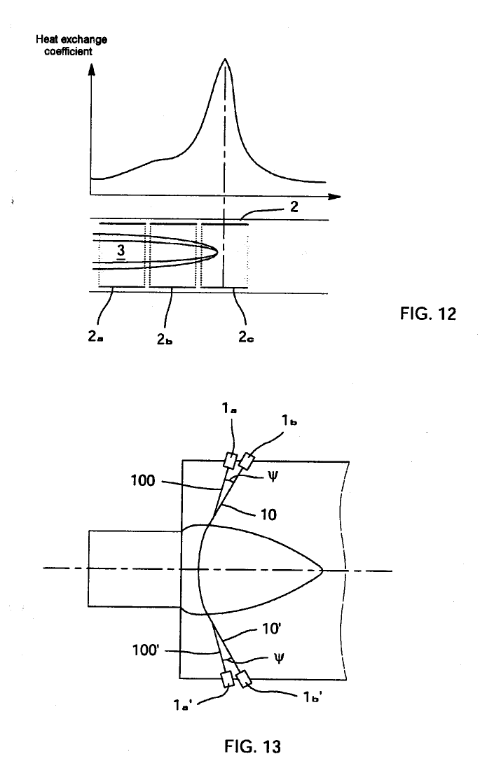

As illustrated in FIG. 12, it may be evidenced that a substantial increase in the flow of heat is to be expected at the level of the injector support 2, a rupture region of the plasma plume 3 favourable to major convective exchange. In this figure, the references 2a, 2b, 2c designate three sections of the support 2 for the injectors. These three sections, when the torch is in operation, are arranged around the plasma plume 3. Section 2c, which corresponds to the end of the plasma plume 3, is the section relative to which the heat exchange coefficient is maximal as indicated in the upper part of FIG. 12.

Part of the support 2 for the injectors can therefore be used to recover part of the heat derived from the plasma plume 3. This recovered heat can then be transferred by conduction to the liquid passing through the injectors. These pre-heating means for the liquid allows its viscosity to be reduced, it therefore becomes more fluid and will be better fragmented in the plasma. Optionally, in the event of heat constraints that are too high at the peak of the exchange coefficient, section 2c can be moved downstream of the plasma flow.

It is recalled that moderate adjustment of the angle of injection in relation to the applied quantity of movement is possible depending on the profiled part of the outlets and in relation to the injection of vapour as already explained above.

The device in FIG. 1A may comprise various additional peripheral means. Said means are schematically illustrated in FIG. 1B.

Means 4 can be provided for example to prepare the liquid feedstock and to pressurize and/or raise the temperature of the liquid to be injected by the injectors into the plasma plume 3.

Optionally, means 5, 5a, 5b can be provided to carry out inspection of the quality of injection.

Means 6 can be used to monitor pulsing of the plasma torch with which the array of injectors is associated.

Data processing means 7a, 7b using data corresponding to various measurements made on the system e.g. data provided by the readjustment means 5a, 5b, 6 can be used, if need be, to readjust the composition of the feedstock and/or plasma operating conditions. For example, these means can be used to adjust e.g. minimize the phase shift between a pulse period of the plasma plume 3 and a pulse period of injection.

According to one example of embodiment, the feedstock preparation means 4 (to place under temperature and pressure) may comprise for example:

a buffer reserve tank 4a for the crude liquid feedstock,

a water tank 4b (this water may be water containing organic residues from wastewater treatment),

a de-mixing tank or water content adjustment tank 4c (so that the conversion reaction may be complete from a stoichiometric viewpoint).

Optionally, a settling tank 4d can be used for rough separation of the phases derived from de-mixing the crude liquid, if de-mixing is possible.

This de-mixing phenomenon (a phase diagram exists for bio-oil for example, as for other specific hydrocarbons; cf. FIG. 15) which is relatively detrimental in a good number of processes, can be used to advantage in the present invention to separate the heavy organic compounds, difficult to convert, from the light phase which is easier to convert, without any major extra cost. Once separated, the heavy phase may advantageously be injected into the core of plasma plume at the outlet of the plasma torch (as close as possible to the base 33, see FIGS. 17 and 18) to draw best benefit from the region optimizing fragmentation, whereas the lighter phase (and in theory easier to convert) can be injected into the tail of the plasma plume or as vapour at the vapour injection nozzles (such as the nozzles 1a, 1a′ in FIG. 13), also allowing the creation of an additional degree of freedom with respect to the angle of injection of the liquid feedstock to be converted.

Filters (here two in number) or separating means (e.g. of centrifugal type) 41, 41′ may be used for finer separation of the phases derived from the settling tank.

A pump 4k′ can be used to recycle the non-desired phase (for example the organic phase in the preparation region of the aqueous phase) in the decanting means 4d.

Means 4h can be used to measure the water content at the output from the de-mixing tank 4c. To control the de-mixing phenomenon, measurement of water content can be provided (for example using Karl Fischer type measurement).

Also, by measuring the elementary composition using means 41 upstream of the point where the organic liquid feed is placed in the buffer volume 4c, it is possible to determine the carbon, oxygen and hydrogen content of the feed to be converted.

It is then possible to know the quantity of water to be added, to guarantee complete gasification (such as described above for reaction 1 for example).

Means 4e to supply pressurized gas (for example: nitrogen, CO₂, methane or water vapour) can be provided above a buffer tank 4f, located on the injection line, to solubilize this gas if necessary in the liquid feed.

This gas, at the output from the injectors may start to desorb and allow adjustment of the composition of the medium (notably the oxidizing species). This solubilisation of a gas followed by its rapid desorption (owing to major temperature and pressure gradients), in the core of the reactor and more especially of the plasma plume, promotes the desired fractionation phenomenon. It is able to lead to the formation of gas droplets within the liquid to be converted, the micro-bursting of these gas droplets under the effect of temperature tending to fractionate the injected liquid locally.

The gas to be solubilized may represent a small mass relative to the liquid to be converted (contrary to atomization using a vector gas). It leads to fractionation of the liquid to be converted but also allows an additional reactant to be provided for this conversion.

Means 4g, 4g′ to pressurize the feed to be converted can ensure its speed of injection and hence its quantity of movement. These means allow adjustment of pressure to maintain continuous or variable pressure as per periodicity and a signal (sinusoidal pressure for example as a function of time) that are adapted to the plasma plume flow; in particular it provides the possibility to cause the injection pressure to oscillate for adaptation to fluctuations of the plasma plume, as evidenced by the oscilloscope 6a for example. These means 4g, 4g′ are driven by the microprocessor 7a.

A system 4j to distribute divided solid and surfactant optionally allows in situ formulation of a feed of slurry type.

A heat exchanger 4m, also optional, can be used to vaporize the aqueous phase before it is injected, for the purpose of forming a vapour phase to be injected separately as already explained above, for example via nozzles 1a, 1a′, 1c, 1c′ in FIG. 1A. To heat this aqueous phase, it is possible to collect the heat from a reactor cooling system and from the electrodes of the plasma torch.

Means 4p, 4o can be used to control proper separation (by settling) by measuring the density of the phases, positioned at the level of the de-mixing settling tank 4d.

Means 4i, 4h, 4o, 4p provide measurements to means of processor type 7a to manage the preparation of the liquid to be injected.

The ducts 40, 41 respectively used to inject the liquid phase and optionally the separate vapour phase, can be heated using a heater strip for example or using the hot gas collected at the output of the torch 3 and injected into a double jacket around the ducts.

A device according to the invention may comprise means 5 to inspect the quality of injection.

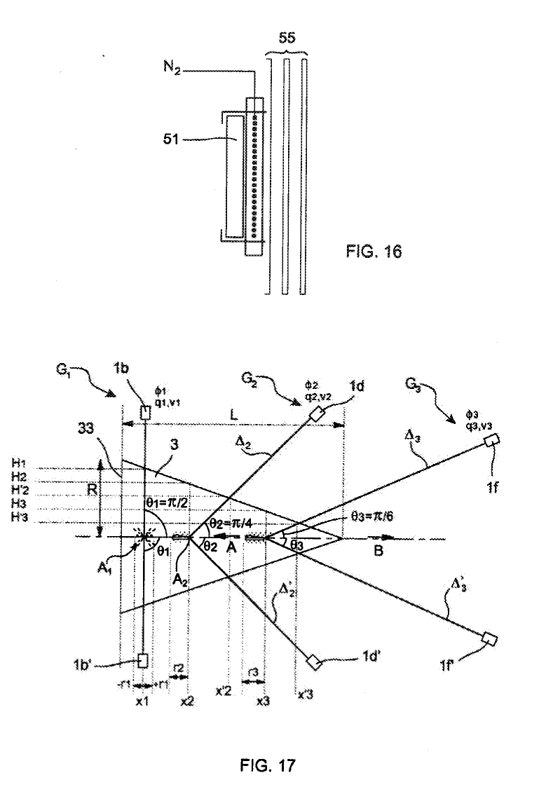

One example of these means is an optical diagnosis assembly 5a which, by image analysis through one or more observation windows 51, 53 as illustrated more precisely in FIG. 16, can diagnose the quality of fragmentation.

Said assembly may comprise a high definition camera 5b for example and a pulsed laser 5b′, to illuminate and visualize the position or movement of droplets of the liquid feedstock inside the plume. Optionally, a filter system 55, associated with the camera 5a and adapted to the type of plasmagenic gases, can be used to overcome the own emissivity of the plasma and to distinguish the droplets of liquid illuminated by the laser beam. A neutral scanning gas (nitrogen in FIG. 16) avoids the depositing of soot on the observation window 51.

A second example of these means is a diagnosis assembly 5c which, at the output of the reactor (or at different points inside the reactor if the residence time of the gases inside the reactor is too long) to monitor the compositions of the permanent gases. From the data obtained with these measurements, a first order of magnitude can be deduced regarding injection performance level (for example by monitoring the conversion rate or level of fragmentation inside the plume.

In parallel, it is possible to couple this measurement with measurement of PID type (Photo-Ionisation Detection, using a UV lamp of energy close to 10.6 eV), so as not to be perturbed by the gaseous matrix of cooled gases, giving production-line estimation of tar and bio-oil content or of the organic feed that is not fully converted. These devices are preceded by a thermal quenching and filter system (conventional and not shown) to freeze the kinetics of species conversion, allow cooling of the gas flow and remove possible traces of soot before passing the flows to be analyzed through the gas phase chromatograph 5c for example and the PID.

In relation to the results of the diagnosis means, the processor means 7a, which may integrate their own regulation system, actuate the driving elements of the injection and feedstock preparation systems (angle of injection, quantity of movement, water content, . . . ) to adapt these parameters.

Additionally, means may be provided to adapt injection of the liquid feed to be converted to possible modifications of the plasma plume, notably to any variations in the pulsing of the torch.

The plume of a non-transferred arc plasma torch may effectively be subject to pulses due to generated instabilities, notably at the time of breaking and re-strike of the electric arc inside the head of the torch. These changes (in particular in temperature) are relatively periodical and can be tracked indirectly by continuous recording of the voltage at the terminals of the electrodes 30, 31 (FIG. 1A) as illustrated in FIG. 21. Since the periodicity of the plume pulses of the torch is relatively constant for a given torch and given operating conditions, it is not necessarily useful (and at all events at times impossible due to pulse frequency) to adapt injection to these pulses in real time. However, it is possible to control non-drifting of periodicity and the good synchronization of pulses with the injections of liquid stream (if these are pulsed) for the purpose in particular of:

limiting the risks of congesting the plasma plume with the feed to be converted,

benefiting from a plasma plume which has best possible efficiency (and hence the hottest) over a given period.

Should any drift in periodicity be ascertained (which can be measured by a fast acquisition oscilloscope 6, FIG. 1B), it is possible to adjust the injection parameters to the chosen periodicity.

To do so, the diagnosis system is also connected to the processor 7a which regularly compares the parameters of periodicity and phase between commanded injection and the pulses of the plasma plume.

The functioning of a device according to the invention can be described as follows.

The plasma torch produces the plasma plume 3, into which the liquid injectors inject the feed to be converted.

Means to prepare the feedstock supply a feed that is adapted to the injectors.

Means to diagnose the quality of injection can check the fragmentation of the streams and monitor the composition of the permanent gases.

Also, control means allow monitoring of the torch pulses.

The diagnosis means, control means and feed preparation means send the information they have collected to data processing means 7a, 7b.

In turn, these data processing means may instruct the feed preparation means to adapt the composition of the feed in relation to the collected information.

The data processing means can also control the pulses of the injectors in relation to the plasma pulses, for example to readjust them to the plasma pulses.

An example of embodiment of an injection system according to the invention will now be described.

This example uses a non-transferred arc plasma torch, of 2 MW electric power, for the optimized conversion of bio-oil through the best injection of bio-oil into the plasma plume.

The following operating data were chosen:

diameter of torch nozzle: 60 mm,

length of plasma plume: 300 mm (the temperature and flow velocity of the plume are assumed to be constant in this region, to simplify calculations),

plume shape: conical,

plume temperature: 7,000 K,

plume density: 3.49·10⁻² kg/m³,

bio-oil density: 1,200 kg/m³,

thermal yield of plasma torch: 90%,

transformation enthalpy of the liquid feed to be converted: 11 MJ/kg (the CxHyOz composition of the feed is assumed to be ideal not necessitating the injection of additional water).

In the light of these data, the maximum capacity of the treatment system (Qmax) is close to 600 kg/h. A reasonable number of 6 injectors can be chosen to ensure this distribution within the plasma plume, the axes of the injectors alternating as illustrated in FIG. 11. FIG. 17, for an arrangement in which the injectors lie in the same plane (the plane of the figure) gives the different denotations for the positioning and angles of the injectors, in particular:

R and L are respectively the radius of the plasma at its base, measured from the plasma flow axis, and the length of the plasma plume from its base,

ri designates the length, measured on the plasma flow axis, of the fragmentation region or of the sheets of liquid at the time the streams converge,

the position, on the plasma flow axis, of each region of convergence of the two streams is designated xi,

Hi designates the position, on an axis perpendicular to the plasma flow axis and placed in the plane of the figure, of the intersection of each perpendicular to the flow axis passing through each point of stream convergence, with one of the longer sides of the triangle schematizing the plasma plume,

x′i (respectively H′i) designates the position on the plasma flow axis (respectively on an axis perpendicular to this flow axis and placed in the plane of the figure) of the orthogonal projection of the intersection of each stream, with the closest side of the triangle schematizing the plasma plume.

With the denotations in FIGS. 17 and 18 (in which the plasma plume is schematized by a triangle), we have:

$${x}^{′} i = \frac{R + xi \cdot tan {θ}_{i}}{R / L + tan {θ}_{i}} ( where i = 2 or 3 ) ,$$

Hi′=tan θi·xi′−tan θi·xi (where i=2 or 3),

Hi=R−R/L·xi (where i=1, 2 or 3).

The Hi values are given in FIG. 17.

Without any specific perturbation, the confluence of the two streams allows the formation of a sheet of liquid to be obtained whose length notably depends on the angle of incidence of the streams. In general, it is possible to estimate the ratio er/(Φ/2)² as a function of angle β such as defined in FIG. 19, in which Φ is the injection diameter of the corresponding injector.

By extrapolating the maxima of r (distance between the point of convergence of the streams 10, 10′ and a current point R of the periphery of the sheet) as a function of the angle of incidence θ of the streams, and taking the thickness e of the sheets 13 to be of lesser order than the radius of the converging liquid streams 10, 10′, the following maximum values (due to the fact that in reality the plasma plume tends to reduce the development of these liquid sheets) of the lengths of the sheets resulting from stream convergence can as a first approximation be given as:

| r₁ | r₂ | r₃ |
|---|---|---|
| ≈3-4 Φ₁ | 22.5 Φ₂ | 45 Φ₃ |

(Φi: being the diameter of injection of the streams by the injectors i).

The elementary volumes δVi defined as described in FIG. 18 then allow the occupancy rates by the liquid feed (τi) to be defined for the elementary volumes encompassing the points of injection.

Let δVi be the elementary volume encompassing the location point xi, the value of this elementary volume has the following expression:

δVi=⅓·π·[ri+(xi′x−xi)]·(Hi′²+Hi+Hi²).

By denoting qi the ratio of the quantity of movement of the stream of the injector i to that of the plasma plume, and Qi the flow rate of liquid from the injector i, the following rule can be made:

if xi increases, then:

θi and Φi, are both reduced but each remain a parameter for conducting of the method;

Qi, also a parameter for conducting of the method, is reduced but ΣQi<Qmax,

τi can be variable, even it tends to become lowered, and remains less than 1%,

qi, also a parameter for conducting the method, is chosen greater than 1 to ensure entry from the plume by the liquid.

By following this rule of configuration, the desired example of embodiment can be the one indicated in Table II, a configuration in which it may be sought, during operation, to minimize ε (distance between two plume occupancy regions by the liquid matter, see FIG. 18) and to adjust the τI values (in the light of diagnostic data on quality of injection) using the conducting parameters θi, Qi and qi:

TABLE II

| Injector 1b, 1b′ | | | | | | | Injector 1d, 1d′ | | | | | | | Injector 1f, 1f′ | | | | | | |
|---|---|---|---|---|---|---|---|---|---|---|---|---|---|---|---|---|---|---|---|---|
| q | v | Φ | Q1 | θ1 | x1 | τ1 | Q | v | Φ | Q | θ2 | x2 | τ2 | Q | V | Φ | Q3 | θ3 | x3 | τ3 |
| 4 | 8 | 3 | 205 | 90° | 50 | 0.9% | 4 | 8 | 1.8 | 75 | 45° | 160 | 0.3% | 1.5 | 5 | 1.2 | 20 | 30° | 230 | 0.3% |
| | m/s | mm | l/h | | mm | | | m/s | mm | l/h | | mm | | | m/s | | l/h | | mm | |

More generally, other than this example, irrespective of the chosen configuration (therefore irrespective of the number of groups of injectors and the number of injectors per groups of injectors) advantageously, for two groups of injectors of which the first is closer to the base 33 of the plasma than the second, the first having parameters τ1, θ1, Φ, q1 and Q1 and the second having parameters τ2, θ2, Φ2, q2 and Q2, the following may be sought:
θ1>θ2 and Φ1>Φ2;
Q1>Q2, but ΣQi<Qmax (Qmax=total flow rate (defined in relation to the thermal power available in the plasma plume and the transformation enthalpy of the feed [energy to convert the feed per mass unit] i.e. here around 600 l/h), τ1 and τ2<1%);
q1 and q2 are both greater than 1.

In general, the device forming the present invention, to ensure best possible conversion of the feed, allows the best compromise to be found between:
optimized fragmentation of the liquid to be converted, permitting optimization of the exchange surface between the liquid and the plasma plume,
a feed residence time in the plume that is as long as possible,
maximized use of the highest temperatures within the plasma plume,
maximized use of the content of active species in the plasma plume, bearing in mind that the conversion of the feed is itself an increasing function of the above-cited parameters (Conversion=f(t, S_{medium/reactant exchange}, T°, Comp)).

The invention applies to the conversion of liquids such as bio-oils, or to sludge from wastewater treatment plants, or to slurries i.e. particles resulting from powdering a solid, these particles being mixed with a liquid for injection into the plasma torch.

The invention also applies to the injection and/or conversion of a liquid of bio-oil type, or more generally which potentially contains fine particles, or still more generally which is relatively difficult to atomize on account of its physicochemical properties (viscosity in particular).

A method to gasify bio-oil allows a gas to be obtained that is adapted to the production of synthetic motor fuel.

As already explained in the introduction, the bio-oil can be obtained by flash pyrolysis, a thermochemical process (at a temperature of T≈500° C.) in which the biomass is heated rapidly in the absence of oxygen. Under the effect of heat, the biomass is broken down and leads to the formation of permanent gases, condensable vapours, aerosols and carbon residues. After cooling and condensation of the volatile compounds and aerosols, typically a dark brown liquid is obtained: bio-oil. This is then gasified by injection into a plasma torch, according to the present invention, which allows the presence of tars to be limited or avoided (below the limit value of 0.1 mg/Nm3).

The invention can also advantageously be applied to processes requiring the use of a plasma plume or of a flame(s) or of a relatively hot fluid(s), or which generate a large quantity of movement not facilitating the mixing of a feed with this plume (or with this flame or this hot liquid or generating a large quantity of movement).

With a system according to the invention, it is also possible to accept variations in density of the liquid to be converted. With other systems, if there is variation in the density of the liquid, adjustment must be made which may be cumbersome.

1. Device to inject liquid matter into a plasma torch, comprising N(N>1) groups of injectors Gi (i=1, . . . N) arranged on the periphery of a plasma flow region, and along the plasma flow axis, each group Gi comprising at least ni (ni≧2) injectors which are arranged so that each injects said liquid matter into the plasma in a direction at least partly opposite the direction of flow of the plasma, the ni injectors of one same group of injectors Gi being arranged on the periphery of the plasma flow region with an angle difference of 360°/(ni) relative to each other, and so that the ni injectors injecting the liquid streams into the plasma each form the generatrix of a cone whose tip lies substantially on the plasma flow.

2. Device according to claim 1, the angle of incidence of the projection axes of the injectors, relative to the plasma flow axis, being smaller the further the injectors lie distant from the base of the plasma plume.

3. Device according to claim 1, at least one injector comprising a piezoelectric element to fractionate the injected liquid.

4. Device according to claim 1, at least one injector comprising an inner helical profile.

5. Device according to claim 1 further comprising means to inject in at least part of the injectors pulsed trains of liquid streams.

6. Device according to claim 1, at least part of the injectors each further comprising a vapour injection nozzle to inject a stream of vapour simultaneously with the stream of liquid.

7. Device according to claim 1, further comprising means to pressurize the liquid feed to be converted.

8. Device according to claim 1, further comprising a tank to separate the heavy organic compounds of the liquid to be converted, and the light phase of this same liquid.

9. Device according to claim 1, further comprising a heat exchanger to vaporize the aqueous phase before it is injected.

10. Device according to claim 1, further comprising optical diagnosis device to control and optionally to adapt the quality of injection of the feed to be converted to changes in the plasma plume.

11. Device according to claim 1, further comprising a microprocessor to adapt the injection of the liquid feed to be converted to changes in the plasma plume.

12. Method to inject liquid matter into a plasma torch, wherein the liquid is injected via N(N>1) groups of injectors Gi (i=1, . . . N) arranged on the periphery of a plasma flow region, each group comprising at least ni (ni≧2) injectors arranged so that each injects at least part of said liquid matter into the plasma in a direction at least partly opposite the direction of flow of the plasma, the ni injectors of one same group of injectors being arranged on the periphery of the plasma flow region with an angle difference of 360°/(ni) relative to each other, and so that the liquid streams they inject into the plasma each form the generatrix of a cone whose tip lies substantially on the plasma flow.

13. Method according to claim 12, the liquid being a bio-oil, or sludge from a wastewater treatment plant, or a slurry.

14. Method according to claim 12, or part of the heat emanated by the plasma being recovered by the support of the injectors and then transferred, by conduction, to the liquid passing through the injectors.

15. Method according to claim 12, wherein, in at least part of the injectors, pulsed trains of liquid streams are injected.

16. Method according to claim 12 wherein, in at least part of the liquid streams, a stream of vapour is injected simultaneously with the stream of liquid.

17. Method according to claim 16, the liquid being previously separated into a first part, vaporizable at a temperature lower than the mean temperature of the plasma, and a second part to be injected into the plasma in liquid form.

18. Method according to claim 12, wherein water is added to the liquid to be injected.

19. Method according to claim 12, wherein a layer of vapour is formed outside the plasma plume.

20. Method according to claim 12, the streams of liquid of the n injectors of one same group of injectors converging in the plasma.

21. Method according to claim 20, the convergence region of the streams lying substantially on the flow axis of the plasma.

22. Method according to claim 12, wherein the angle of injection of at least one stream into the plasma is modified.

23. Method according to claim 22, wherein the angle of injection of at least one stream is modified by varying the pressure of the liquid in this stream.

24. Method according to claim 12, wherein a quantity of rotational movement is applied to at least one stream of liquid.

25. Method according to claim 12, wherein liquid is injected by the injectors of different groups of injectors comprising different angles of incidence with the plasma flow axis.
